(19) United States
(12) Patent Application Publication
(10) Pub. No.: US 2016/0241778 A1
(43) Pub. Date: Aug. 18, 2016

(54) SYNCHRONIZATION OF MULTIPLE SINGLE LENS CAMERA DEVICES

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, Kolkata (IN); Craig M. Trim, Sylmar, CA (US)

(21) Appl. No.: 14/621,538

(22) Filed: Feb. 13, 2015

(51) Int. Cl. H04N 5/232

(52) U.S. Cl. CPC H04N 5/23222

(57) ABSTRACT

A method of capturing a single focus-stacked image by synchronizing a primary device with a single lens and one or more secondary devices having a single lens comprising the steps of the primary device: obtaining data regarding the image to be captured; selecting one or more secondary devices; sending data regarding the image to be captured to at least one of the selected one or more secondary devices; setting a focal point on at least one object to be captured in the image; sending a focal point adjustment to the selected one or more secondary devices to focus on at least one other object to be captured in the image; initiating capture of the image on the primary device and the selected one or more secondary devices at a synchronized time; and capturing the image.

### BACKGROUND

The present invention relates to images, and more specifically to synchronizing multiple single lens camera devices to take substantially the same image at the same time.

One of the ways of achieving a deep focus image, where the depth of field is large and the foreground, middle-ground and background are all in focus, is to use a dual camera with dual lenses where each of the camera modules is able to simultaneously output recorded images and depth data.

### SUMMARY

According to one embodiment of the present invention, a method of capturing a single focus-stacked image by synchronizing a primary device with a single lens and one or more secondary devices having a single lens. The method comprising the steps of: the primary device obtaining data regarding the image to be captured; the primary device selecting one or more secondary devices; the primary device sending data regarding the image to be captured to at least one of the selected one or more secondary devices; the primary device setting a focal point on at least one object to be captured in the image; the primary device sending a focal point adjustment to the selected one or more secondary devices to focus on at least one other object to be captured in the image; the primary device initiating capture of the image on the primary device and the selected one or more secondary devices at a synchronized time; and the primary device capturing the image.

According to another embodiment of the present invention, a method of capturing a single focus-stacked image by synchronizing a primary device with a single lens and a secondary device having a single lens. The method comprising the steps of the secondary device: receiving data from the primary device regarding the image to be captured; aligning the single lens of the secondary device to capture the image based on the data received from the primary device; sending a notification to the primary device that the secondary device is aligned for capturing the image; receiving a focal point adjustment from the primary device; adjusting the focal point of the secondary device to match the focal point adjustment received from the primary device; receiving an initiation of capture of the image from the primary device; and capturing the image.

According to another embodiment of the present invention, a computer program product for capturing a single focus-stacked image by synchronizing a primary device with a single lens and one or more secondary devices having a single lens. The primary device comprises at least one processor, one or more memories, one or more computer readable storage media. The computer program product comprising a computer readable storage medium having program instructions embodied therewith, the program instructions executable by the computer to perform a method comprising: obtaining, by the primary device, data regarding the image to be captured; selecting, by the primary device, one or more secondary devices; sending, by the primary device, data regarding the image to be captured to at least one of the selected one or more secondary devices; setting, by the primary device, a focal point on at least one object to be captured in the image; sending, by the primary device, a focal point adjustment to the selected one or more secondary devices to focus on at least one other object to be captured in the image; initiating, by the primary device, capture of the image on the primary device and the selected one or more secondary devices at a synchronized time; and capturing, by the primary device the image.

BRIEF DESCRIPTION OF THE SEVERAL VIEWS OF THE DRAWINGS

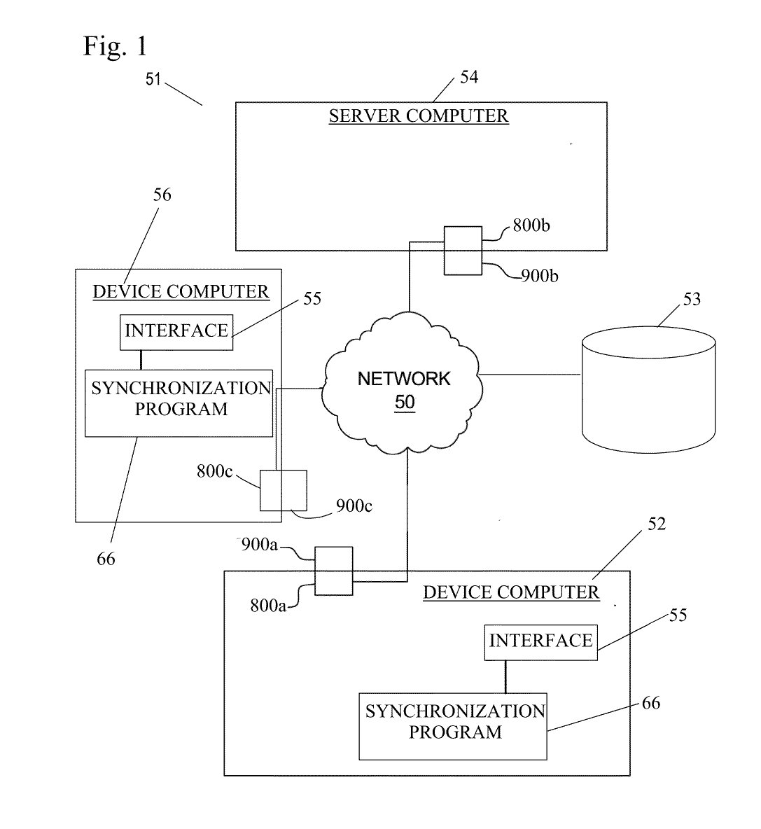

FIG. 1 depicts an exemplary diagram of a possible data processing environment in which illustrative embodiments may be implemented.

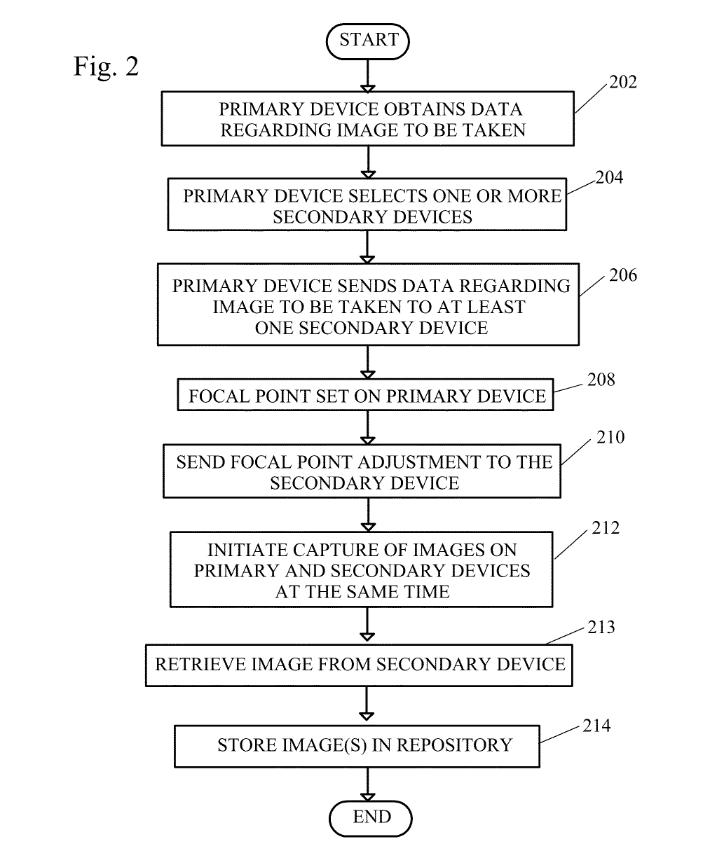

FIG. 2 shows a flow diagram of a method of synchronizing, by a primary device, multiple single lens devices to take substantially the same image at the same time.

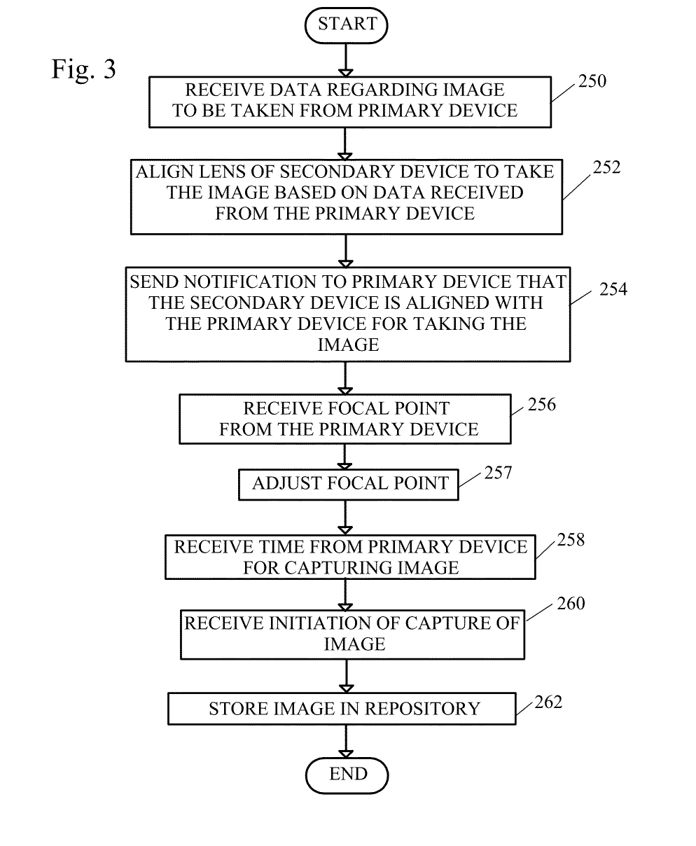

FIG. 3 shows a flow diagram of a method of synchronizing a single lens of one or more secondary devices to take substantially the same image at the same time by a primary device.

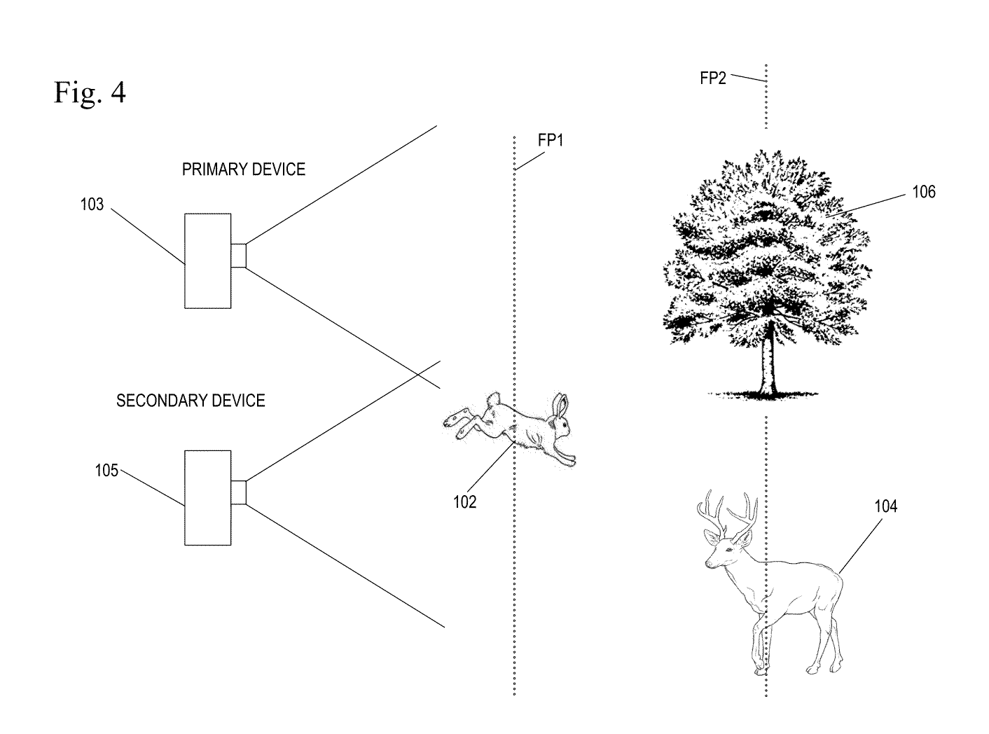

FIG. 4 shows an example of synchronizing multiple single lens devices to take substantially the same image at the same time.

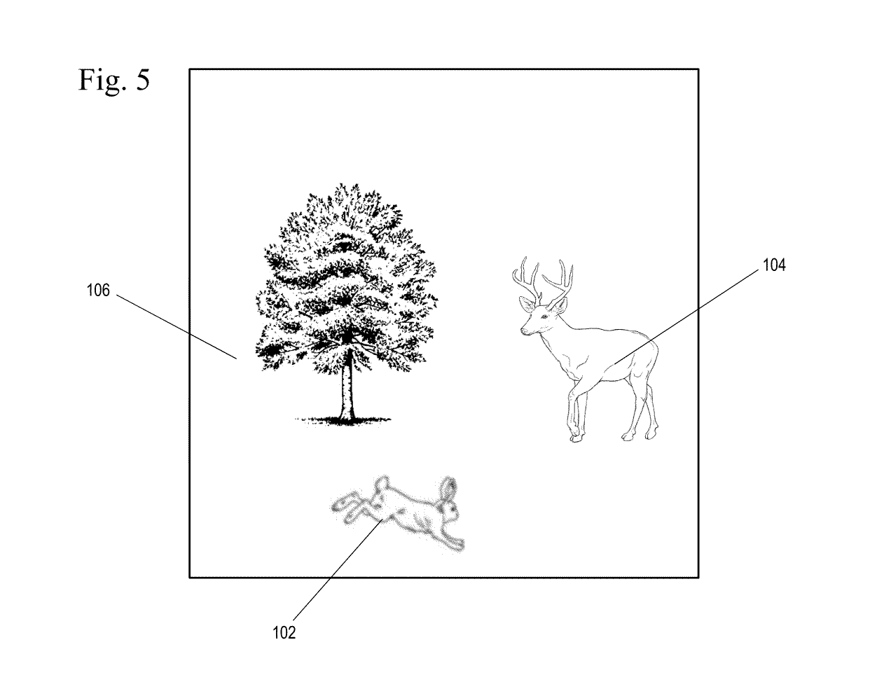

FIG. 5 shows an example of an image taken by a primary device in the example of FIG. 4.

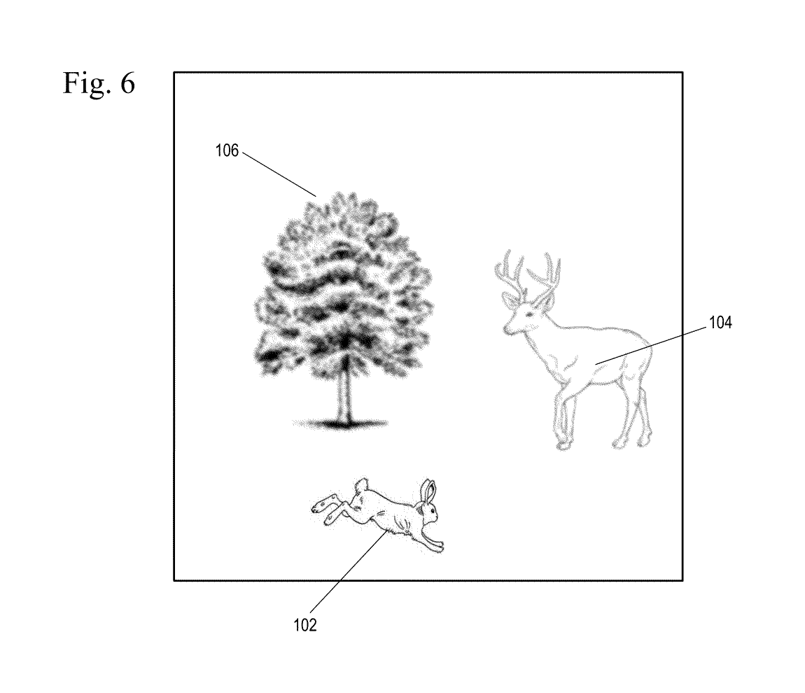

FIG. 6 shows an example of an image taken by a secondary device in the example of FIG. 4.

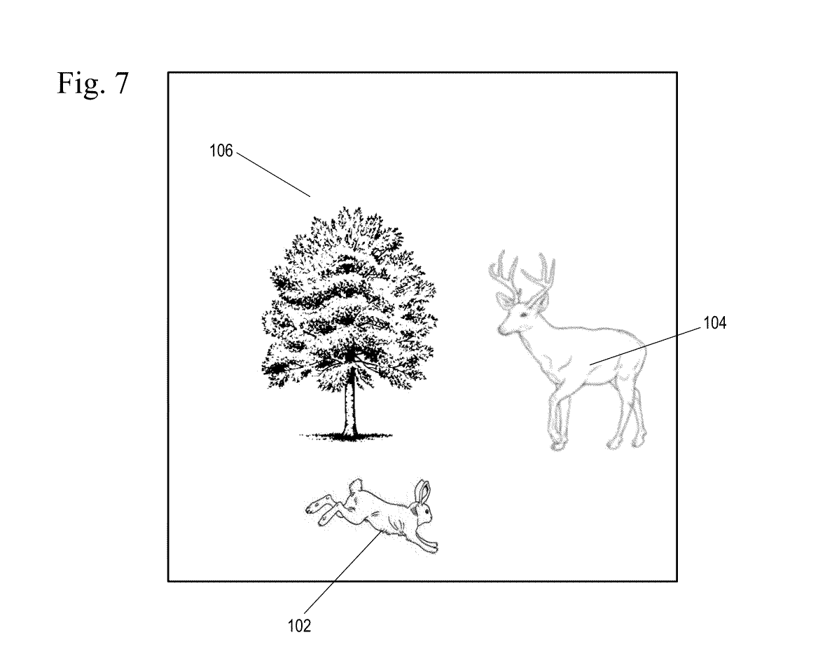

FIG. 7 shows an example of a focus-stacked image produced from the merger of the image from FIG. 5 and the image from FIG. 6.

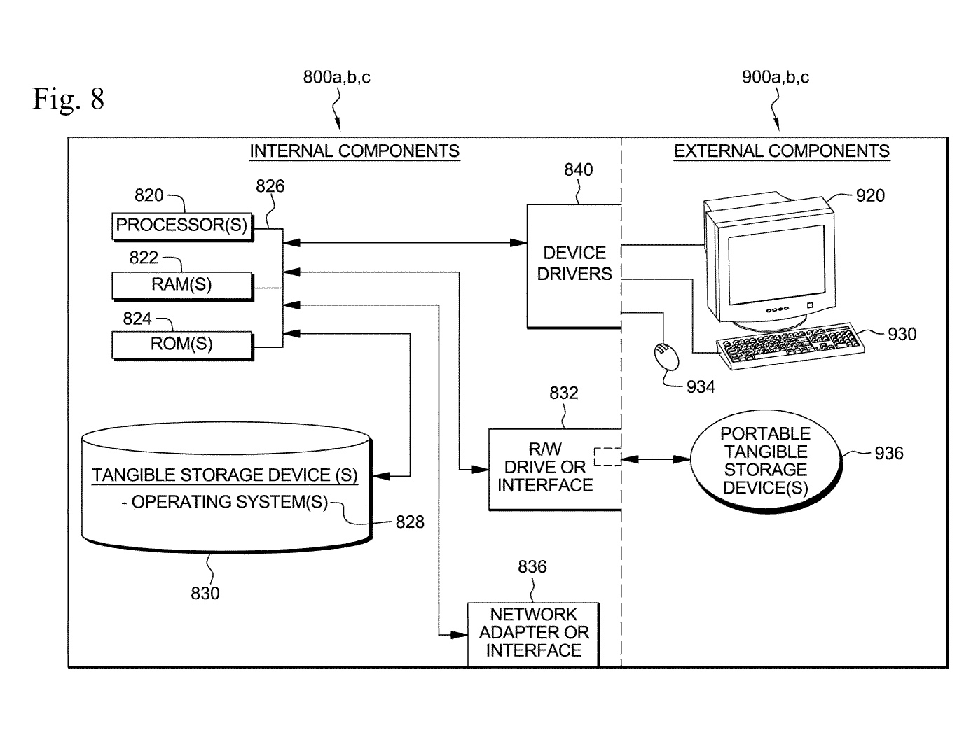

FIG. 8 illustrates internal and external components of a client or device computer and a server computer in which illustrative embodiments may be implemented.

### DETAILED DESCRIPTION

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, another device computer 56, a repository 53, and a server computer 54 connect to network 50. In other exemplary embodiments, network data processing system 51 may include additional client or device computers, storage devices or repositories, server computers, and other devices not shown.

Device computer 52 and another device computer 56 each includes a set of internal components 800, 800c a and a set of external components 900a, 900c further illustrated in FIG. 8. Device computer 52 and device computer 56 may be, for example, a mobile device, a cell phone, a personal digital assistant, a netbook, a laptop computer, a tablet computer, a desktop computer, a camera, or any other type of computing device capable of sending electronic communications to at least one recipient.

Device computer 52 and device computer 56 each contain an interface 55. The interface 55 may accept commands and data entry from a user. The interface 55 can be, for example, a command line interface, a graphical user interface (GUI), or a web user interface (WUI). The device computer 52 and device computer 56 each preferably includes a synchronization program 66. The device computers 52 and 56 may also have displays. While not shown, it may be desirable to have the synchronization program 66 on the server computer 54.

Repository 53 may contain images taken by either of the device computers 52, 56. The images may be altered through an interface 55 on the device computers 52, 56, through an interface (not shown) of the server computer 54, or some other device. The repository 53 may be searchable through an interface 55 on the device computers 52, 56, through an interface (not shown) of the server computer 54, or some other device.

Server computer 54 includes a set of internal components 800b and a set of external components 900b illustrated in FIG. 8. The server computer preferably 54 includes or may be communications server, which can facilitate communication between the device computers 52, 56.

In the depicted example, server computer 54 provides information, such as boot files, operating system images, and applications to device computers 52, 56. Server computer 54 can compute the information locally or extract the information from other computers on network 50.

Program code and programs such as a synchronization program 66 may be stored on at least one of one or more computer-readable tangible storage devices 830 shown in FIG. 8, on at least one of one or more portable computer-readable tangible storage devices 936 as shown in FIG. 8, on repository 53 connected to network 50, or downloaded to a data processing system or other device for use. For example, program code and programs such as a synchronization program 66 may be stored on at least one of one or more tangible storage devices 830 on server computer 54 and downloaded to the device computers 52, 56. Alternatively, server computer 54 can be a web server, and the program code and programs such as a synchronization program 66 may be stored on at least one of the one or more tangible storage devices 830 on server computer 54 and accessed on the device computers 52, 56. Synchronization program can be accessed on device computers 52, 56 through interface 55. In other exemplary embodiments, the program code and programs such as a synchronization program 66 may be stored on at least one of one or more computer-readable tangible storage devices 830 on server computer 54 or distributed between two or more servers.

The images from multiple devices, each with a single camera lens, are synchronized to overlay and create one image. Each device captures substantially the same image. Each of the images taken can be focused on an object at a different distance from the device taking the image (the “focal point”), so that when the individual images are combined together they provide clarity to all of the individual objects within the combined image. This is referred to as “focus stacking”. Small differences in backgrounds and angles between the images may be adjusted for through software.

One of the devices is designated as the “primary” device. The primary device may be device computer 52 or device computer 56 of FIG. 1. The primary device is the device that sets the zoom level, direction, focal point, and background of the image to be taken. The primary device also sets the synchronization of one or more secondary devices to capture the image at substantially the same time via wireless technology, such as Bluetooth or through some other communication.

The other of device computer 52 or device computer 56 of FIG. 1 is a secondary device. The secondary device receives information, via wireless technology, regarding what image to take, the focal point at which to capture the image and when to capture the image in synchronization with the primary device and any other secondary devices.

Software may be used to perform focus stacking of at least two images taken at approximately the same time of the approximately the same objects. The software may also be used to replace a part of one of the images if an object is blocked or did not come out clearly. An example of software which can be used to provide focus stacking and partial image replacement is a photo-editing program such as Adobe PhotoShop®.

FIG. 4 shows an example of synchronizing multiple single lens devices to take substantially the same image at the same time.

A primary device 103 with a single lens is present to capture an image of a deer 104 and a rabbit 102 near a tree 106. The deer 104 and the tree 106 are along the same distance or focal plane FP2, while the rabbit 102 is in a closer focal plane FP1. For the purpose of this example, it is assumed that the depth of field of the primary device 103 and the secondary device 105 is insufficient to have objects at both FP1 and FP2 in focus at the same time.

A user may align the primary device 103 to capture an image of the user's choice. The primary device 103 obtains data regarding the image to be taken. The data may include, but is not limited to zoom level, current pointed position, for example through a compass, focal point, and a copy of the image the lens is “seeing” or the image present on a display of the primary device 103 to the user of the image to be captured. The primary device may, for example be device computer 52 of FIG. 1.

The primary device 103 selects one or more secondary devices 105 to take substantially the same image as the primary device 103. The primary device 103 preferably chooses one or more secondary devices 105 within a specific proximity of the primary device 103. The secondary device 105 may, for example be device computer 56 of FIG. 1.

The primary device 103 sends data regarding the image to be taken to the one or more secondary devices 105. The data may include, but is not limited to exposure, aperture, focal length, ISO speed, exposure bias, flash, orientation of the device, location, compass position, zoom level, focal point, and a copy of the image the lens is “seeing” or the image present on a display to the user of the primary device for the image. The focal point and/or amount of zoom may be different between the primary device 103 and the one or more secondary devices 105 or alternatively between each of the secondary devices 105. For the example, the primary device 103 may focus on focal plane FP2 containing the deer 104 next to the tree 106 and the secondary device 105 may focus on focal plane FP1 containing the running rabbit 102.

The secondary device 56 may lead a user of the one or more secondary devices 105 to manually adjust one or more of the settings of the secondary device 105. Alternatively, the secondary device 105 may automatically adjust the settings of the secondary device 105 as determined by the primary device 103.

The primary device 103 may receive notifications sent by the one or more secondary devices 105 when information regarding the image is received and when the adjustments to the secondary device 105 are complete.

The primary device 103 and the secondary device 105 are synchronized by the primary device 103 to initiate capture of the primary and secondary devices 105 at substantially the same time. The synchronization may be accomplished by the primary device 103 sending a time in which to capture the image based on a synchronized real-time clock of each of the devices. The real-time clocks of the devices can be synchronized to each other, or derived from an outside source such as radio signals from an atomic clock (as are transmitted by NIST radio stations WWV or WWVB) or a GPS satellite. Through the synchronization of the primary device 103 and one or more secondary devices 105, the capturing of the image or “clicking” takes place at substantially the same time.

Referring back to the example, the primary camera 103 would focus on FP2 containing the deer 104 and tree 106, causing the rabbit 102 to be slightly out of focus, as shown in FIG. 5. The secondary camera 105 would focus on FP1 containing the rabbit 102, which would cause the deer 104 and tree 106 to be slightly out of focus as shown in FIG. 6. The primary camera 103 synchronizes with the secondary device 105 so that primary and the secondary devices 103, 105 snap the image at substantially the same time. It will be understood that while two devices 103 and 105, focusing at two focal planes FP1 and FP2, are shown and discussed herein, that the method is equally applicable to three or more devices and focal planes. After capturing the images, the individual images from the devices 103 and 105 can be focus stacked, as shown FIG. 7, and the deer 104, tree 106 and rabbit 102 will all be in focus in the final image.

FIG. 2 shows a flow diagram of a method of synchronizing, by a primary device, multiple single lens devices to take substantially the same image at the same time.

A primary device obtains data regarding an image to be taken (step 202), for example by the synchronization program 66 or by having a user point the device at a scene he would like to capture and entering an indication such as by pushing a shutter button or tapping a touch screen. The data may be, but is not limited to exposure, aperture, focal length, ISO speed, exposure bias, flash, orientation and elevation angle of the device, device location, compass direction in which the lens is pointed, or zoom level.

The primary device selects one or more secondary devices (step 204). The secondary device may be within a specific proximity of the primary device.

The primary device sends data regarding the image to be taken to at least one secondary device (step 206), for example by the synchronization program 66. The data sent may be the data obtained regarding the image to be taken, and additionally may include an image of what the primary device's lens is “seeing” or the image present on a display to the user of the primary device for the image. The image may be displayed to the user of the secondary devices as a “ghost image” or outline of the objects to be in the captured image.

The primary device sets the focal point based on the data regarding the image to be taken (step 208), for example by the synchronization program 66. A focal point adjustment is sent to the secondary device (step 210). The focal point between the primary device and a secondary device is different. If multiple secondary devices are being used, the focal point may different between the secondary devices.

The synchronization program 66 of the primary device initiates the capture of the images on the primary and secondary devices at substantially the same time (step 212). The synchronization may take place by using an image capture time derived from, for example, synchronized real-time clocks in each of the primary and secondary devices.

Optionally, the primary device may retrieve the images taken by the secondary devices (step 213).

The image captured by the primary device (and the images from the secondary devices, if they have been retrieved by the primary device) is stored in a repository (step 214).

A user may then use software to retrieve images taken by the primary and other secondary devices and focus stack the images to form a single image.

FIG. 3 shows a flow diagram of a method of synchronizing a single lens of one or more secondary devices to take substantially the same image at the same time by a primary device.

One or more secondary devices receives data regarding an image to be taken by a primary device (step 250), for example by a synchronization program 66.

The secondary device aligns the lens of the secondary device to take substantially the same image as the primary device based on the data received (step 252). The data may be, but is not limited to exposure, aperture, focal length, ISO speed, exposure bias, flash, orientation of the device, location, compass position, zoom level, focal point, and a copy of the image the lens is “seeing” or the image present on a display to the user of the primary device for the image. The secondary device may automatically change its settings to match the data received from the primary device, or the synchronization program 66 may lead a user through manually adjusting the secondary device's settings to match the primary device's settings.

The secondary device sends a notification to the primary device that the settings of the secondary device are aligned with the primary device for taking substantially the same image (step 254), for example through the synchronization program. The communication may take place wirelessly, for example through WiFi, Zigbee or BlueTooth® radio signals, or by infrared signals as are commonly used in camera or TV remote controls.

The secondary device receives a focal point from the primary device (step 256), which may be different from the focal point used by the primary device itself. The secondary device adjusts the focal point to match the focal point received from the primary device (step 257).

The secondary device receives a time for capturing the image from the primary device (step 258), for example through the synchronization program 66. The secondary device receives initiation of capture of the image (step 260), for example through the synchronization program 66.

The image captured by the secondary device is stored in a repository (step 262), and/or, optionally, transmitted to the primary device.

FIG. 8 illustrates internal and external components of device computer 52 and server computer 54 in which illustrative embodiments may be implemented. In FIG. 8, device computer 52 and server computer 54 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, and synchronization program 66 are stored on one or more of the computer-readable tangible storage devices 830 for execution by one or more of the processors 820 via one or more of the RAMs 822 (which typically include cache memory). In the embodiment illustrated in FIG. 8, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Synchronization program 66 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. Synchronization program 66 can be downloaded to the device computer 52 and server computer 54 from an external computer via a network (for example, the Internet, a local area network or other, wide area network) and network adapter or interface 836. From the network adapter or interface 836, synchronization program 66 is loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Synchronization program 66 can be written in various programming languages including low-level, high-level, object-oriented or non object-oriented languages. Alternatively, the functions of a synchronization program 66 can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having thus described the invention of the present application in detail and by reference to embodiments thereof, it will be apparent that modifications and variations are possible without departing from the scope of the invention defined in the appended claims.

What is claimed is:

1. A method of capturing a single focus-stacked image by synchronizing a primary device with a single lens and one or more secondary devices having a single lens comprising the steps of:
the primary device obtaining data regarding the image to be captured;
the primary device selecting one or more secondary devices;
the primary device sending data regarding the image to be captured to at least one of the selected one or more secondary devices;
the primary device setting a focal point on at least one object to be captured in the image;
the primary device sending a focal point adjustment to the selected one or more secondary devices to focus on at least one other object to be captured in the image;
the primary device initiating capture of the image on the primary device and the selected one or more secondary devices at a synchronized time; and
the primary device capturing the image.

2. The method of claim 1, wherein the primary device selects one or more secondary devices within a proximity of the primary device.

3. The method of claim 1, further comprising the steps of the primary device storing the image captured in a repository.

4. The method of claim 1, wherein the data regarding the image to be captured and sent to at least one of the selected one or more secondary devices comprises an image of objects to be captured.

5. The method of claim 1, wherein prior to initiating capture of the image on the primary device and the selected one or more secondary devices further comprising the step of the primary device receiving a notification from the secondary device that the secondary device is aligned for capturing the image.

6. The method of claim 1, further comprising the steps of retrieving images from the one or more secondary devices and combining the image captured by the primary device with the images retrieved from the one or more secondary devices to produce a single focus-stacked image.

7. A method of capturing a single focus-stacked image by synchronizing a primary device with a single lens and a secondary device having a single lens comprising the steps of the secondary device:
receiving data from the primary device regarding the image to be captured;
aligning the single lens of the secondary device to capture the image based on the data received from the primary device;
sending a notification to the primary device that the secondary device is aligned for capturing the image;
receiving a focal point adjustment from the primary device;
adjusting the focal point of the secondary device to match the focal point adjustment received from the primary device;
receiving an initiation of capture of the image from the primary device; and
capturing the image.

8. The method of claim 7, further comprising the step of storing the captured image in a repository.

9. The method of claim 7, wherein the data regarding the image to be captured received from the primary device comprises an image of objects to be captured.

10. The method of claim 7, wherein prior to the secondary device sending a notification to the primary device that the secondary device is aligned for capturing the image, the secondary device automatically adjusting the single lens of the secondary device to match data for alignment of the secondary device to capture the image.

11. The method of claim 7, wherein prior to the secondary device sending a notification to the primary device that the secondary device is aligned for capturing the image, the secondary device providing instructions to a user to adjust the single lens of the secondary device to match the data for alignment of the secondary device to capture the image.

12. The method of claim 7 in which the step of initiating the capture of the image comprises receiving a time for capturing the image from the primary device.

13. The method of claim 7 further comprising transmitting the image to the primary device.

14. A computer program product for capturing a single focus-stacked image by synchronizing a primary device with a single lens and one or more secondary devices having a single lens the primary device comprising at least one processor, one or more memories, one or more computer readable storage media, the computer program product comprising a computer readable storage medium having program instructions embodied therewith, the program instructions executable by the computer to perform a method comprising:
obtaining, by the primary device, data regarding the image to be captured;
selecting, by the primary device, one or more secondary devices;
sending, by the primary device, data regarding the image to be captured to at least one of the selected one or more secondary devices;
setting, by the primary device, a focal point on at least one object to be captured in the image;
sending, by the primary device, a focal point adjustment to the selected one or more secondary devices to focus on at least one other object to be captured in the image;
initiating, by the primary device, capture of the image on the primary device and the selected one or more secondary devices at a synchronized time; and
capturing, by the primary device the image.

15. The computer program product of claim 14, wherein the primary device selects one or more secondary devices within a proximity of the primary device.

16. The computer program product of claim 14, further comprising storing by the primary device, the image captured in a repository.

17. The computer program product of claim 14, wherein the data regarding the image to be captured and sent to at least one of the selected one or more secondary devices comprises an image of objects to be captured.

18. The computer program product of claim 14, wherein prior to initiating capture of the image on the primary device and the selected one or more secondary devices further comprising the step of receiving, by the primary device, a notification from the secondary device that the secondary device is aligned for capturing the image.

19. The computer program product of claim 14, further comprising the steps of retrieving, by the primary device, images from the one or more secondary devices and combining the image captured by the primary device with the images retrieved from the one or more secondary devices to produce a single focus-stacked image.
